(19) United States
(12) Patent Application Publication
(10) Pub. No.: US 2018/0298155 A1
(43) Pub. Date: Oct. 18, 2018

(54) CURABLE COMPOSITION, CURED PRODUCT, PREPREG AND FIBER-REINFORCED MOLDED PRODUCT

(71) Applicant: ASAHI GLASS COMPANY, LIMITED, Chiyoda-ku (JP)

(72) Inventors: Tomoya Hosoda, Chiyoda-ku (JP); Takashi Sato, Chiyoda-ku (JP); Masatoshi Abe, Chiyoda-ku (JP)

(73) Assignee: ASAHI GLASS COMPANY, LIMITED, Chiyoda-ku (JP)

(21) Appl. No.: 15/997,191

(22) Filed: Jun. 4, 2018

Related U.S. Application Data
(63) Continuation of application No. PCT/JP2017/000874, filed on Jan. 12, 2017.

(30) Foreign Application Priority Data
Jan. 14, 2016 (JP) 2016-005275

(51) Int. Cl. C08J 5/24; C08L 63/00

(52) U.S. Cl. CPC C08J 5/24; C08J 2427/18; C08J 2363/02; C08L 63/00

(57) ABSTRACT

To provide a curable composition capable of obtaining a cured product excellent in outer appearance and abrasion resistance; a cured product excellent in outer appearance and abrasion resistance; a prepreg capable of obtaining a fiber-reinforced molded product excellent in outer appearance and abrasion resistance; and a fiber-reinforced molded product excellent in outer appearance and abrasion resistance. The curable composition comprises a thermosetting resin, a fluororesin powder and a curing agent, wherein the fluororesin powder is made of a resin material containing a melt-moldable fluororesin having a melting point of from 100 to 325° C. and having functional groups of at least one type selected from the group consisting of carbonyl group-containing groups, hydroxy groups, epoxy groups and isocyanate groups, and in 100 mass % of the total of the thermosetting resin and the fluororesin powder, the proportion of the thermosetting resin is from 70.0 to 99.9 mass % and the proportion of the fluororesin powder is from 0.1 to 30 mass %.

### TECHNICAL FIELD

The present invention relates to a curable composition, a cured product obtained by curing the curable composition, a prepreg using the curable composition, and a fiber-reinforced molded product using the prepreg.

### BACKGROUND ART

Fiber-reinforced molded products have been employed in a wide range of applications including transport equipment (vehicles (automobiles, railway vehicles, etc.), aircrafts, etc.), building components, electronic devices, etc. As matrix resins for the fiber-reinforced molded products, cured products of thermosetting resins have been commonly used.

However, since the cured products of the thermosetting resins are brittle, the fiber-reinforced molded products wherein cured products of thermosetting resins are used as the matrix resins, have such a problem that impact resistance or toughness is insufficient.

Therefore, as a prepreg to improve the impact resistance or toughness of a fiber-reinforced molded product, one has been proposed wherein a curable composition having a resin powder or a thermoplastic resin added to a thermosetting resin, is employed as the matrix resin (e.g. Patent Documents 1 and 2).

### PRIOR ART DOCUMENTS

### Patent Documents

Patent Document 1: JP-A-S63-162732

Patent Document 2: JP-A-2007-191633

### DISCLOSURE OF INVENTION

### Technical Problem

Abrasion resistance is required for a member to be used as a sliding part in transportation equipment, etc. However, a conventional fiber-reinforced molded product is not always sufficient in abrasion resistance, and further improvement in abrasion resistance is desired.

The present invention is to provide a curable composition capable of obtaining a cured product excellent in outer appearance and abrasion resistance, a cured product excellent in outer appearance and abrasion resistance, a prepreg capable of obtaining a fiber-reinforced molded product excellent in outer appearance and abrasion resistance, as well as a fiber-reinforced molded product excellent in outer appearance and abrasion resistance.

### Solution to Problem

The present invention has the following embodiments.

<1> A curable composition comprising a thermosetting resin, a fluororesin powder and a curing agent, wherein the fluororesin powder is made of a resin material containing a melt-moldable fluororesin having a melting point of from 100 to 325° C. and having functional groups of at least one type selected from the group consisting of carbonyl group-containing groups, hydroxy groups, epoxy groups and isocyanate groups, and in 100 mass % of the total of the thermosetting resin and the fluororesin powder, the proportion of the thermosetting resin is from 92 to 99.9 mass % and the proportion of the fluororesin powder is from 0.1 to 8 mass %.
<2>. The curable composition according to <1>, wherein in 100 mass % of the total of the thermosetting resin and the fluororesin powder, the proportion of the thermosetting resin is from 92 to 99.9% and the proportion of the fluororesin powder is from 0.1 to 8 mass %.
<3> The curable composition according to <1> or <2>, wherein the average particle diameter of the fluororesin powder is from 0.02 to 200 μm.
<4> The curable composition according to any one of <1> to <3>, wherein the melting point of the fluororesin is from 100 to 260° C.
<5> The curable composition according to any one of <1> to <4>, wherein the melt flow rate of the fluororesin is from 0.5 to 100 g/10 min. at a temperature higher by at least 20° C. than the melting point of the fluororesin (B) under a condition of a load of 49N.
<6> The curable composition according to any one of <1> to <5>, wherein the fluororesin is a fluorinated polymer having functional groups (f) derived from at least one member selected from the group consisting of a monomer, a chain transfer agent and a polymerization initiator used at the time of producing the fluorinated polymer.
<7> The curable composition according to any one of <1> to <6>, wherein the fluororesin is a fluorinated polymer comprising units derived from tetrafluoroethylene or chlorotrifluoroethylene, units derived from a cyclic hydrocarbon monomer having an acid anhydride group and units derived from a fluorinated monomer (excluding TFE and CTFE).
<8> The curable composition according to any one of <1> to <7>, wherein the proportion of the curing agent is from 25 to 45 parts by mass, to 100 parts by mass of the total of the thermosetting resin (A) and the fluororesin powder (X).
<9> A cured product of the curable composition as defined in any one of <1> to <8>.
<10> The cured product according to <9>, which has a thickness at most 5 mm.
<11> A metal laminate plate having a metal layer on one side or each side of a layer composed of the cured product as defined in <9> or <10>.
<12> A prepreg comprising reinforcing fibers and a matrix resin, wherein the matrix resin is composed of the curable composition as defined in any one of <1> to <8>.
<13> A fiber-reinforced molded product using the prepreg as defined in <12>.

### Advantageous Effects of Invention

According to the curable composition of the present invention, it is possible to obtain a cured product excellent in outer appearance and abrasion resistance. The cured product of the present invention is excellent in outer appearance and abrasion resistance. According to the prepreg of the present invention, it is possible to obtain a fiber-reinforced molded product excellent in outer appearance and abrasion resistance. The fiber-reinforced molded product of the present invention is excellent in outer appearance and abrasion resistance.

### DESCRIPTION OF EMBODIMENTS

The following definitions of terms apply throughout the specification including claims.

The “melting point” is the temperature corresponding to the maximum value of the melting peak as measured by a differential scanning calorimetry (DSC) method.

Being “melt-moldable” means to show a melt flowability.

“Showing a melt flowability” means that a temperature at which the melt flow rate becomes to be from 0.1 to 1,000 g/10 min. is present under a load of 49N at a temperature higher by at least 20° C. than the melting point of the resin.

The “melt flow rate” is a melt mass flow rate (MFR) as specified in JIS K7210; 1999 (ISO 1133; 1997).

A “unit” refers to a moiety (polymerized unit) derived from a monomer, i.e. formed by polymerization of the monomer. A unit may be a unit formed directly by a polymerization reaction, or a unit having a part of the unit converted to another structure by treating the polymer.

The “average particle diameter of a powder” is a volume-based cumulative 50% diameter (D50) determined by a laser diffraction scattering method. That is, the particle size distribution is measured by a laser diffraction scattering method, to obtain a cumulative curve based on the total volume of the population of particles being 100%, whereby it is the particle diameter at the point where the cumulative volume becomes 50% on the cumulative curve.

### <Curable Composition>

The curable composition of the present invention comprises a thermosetting resin (A), a fluororesin powder (X) and a curing agent (C).

The curable composition of the present invention may contain, within a range not to impair the effects of the present invention, a thermoplastic resin (D), or a component other than the thermosetting resin (A), the fluororesin powder (X), the curing agent (C) and the thermoplastic resin (D).

(Thermosetting Resin (A))

The thermosetting resin (A) may be an epoxy resin, a cyanate ester resin, an unsaturated polyester resin, a vinyl ester resin, a phenol resin, a urea-melamine resin, a polyimide, a bismaleimide resin, etc. (but excluding the same one as the fluororesin (B) described below).

As the thermosetting resin, from the viewpoint of the mechanical properties of the cured product or the fiber-reinforced molded product, an epoxy resin or a cyanate ester resin is preferred, and an epoxy resin is more preferred.

The epoxy resin may be a glycidyl ether-type epoxy resin (a bisphenol-type epoxy resin, a (poly)alkylene glycol-type epoxy resin, a phenol novolac-type epoxy resin, an ortho-cresol novolac-type epoxy resin, etc.), a glycidyl ester-type epoxy resin, a glycidyl amine-type epoxy resin (N,N,N′,N′-tetraglycidyl diaminodiphenylmethane, triglycidyl-p-aminophenol, triglycidyl isocyanurate, etc.), an alicyclic epoxy resin (dicyclopentadiene-type, etc.), an epoxy resin having a sulfur atom in the main chain, a urethane-modified epoxy resin, a rubber-modified epoxy resin, etc. As the epoxy resin, one type may be used alone, or two or more types may be used in combination.

The thermosetting resin may be in a form which is soluble in a liquid medium. The liquid medium Is not particularly limited and may be an alcohol-type solvent such as methanol, ethanol, etc., a ketone-type solvent such as acetone, methyl ethyl ketone, methyl isobutyl ketone, etc., an ether-type solvent such as methyl cellosolve, ethyl cellosolve, etc., a sulfoxide-type solvent such as dimethyl sulfoxide, diethyl sulfoxide, etc., a formamide-type solvent such as N,N-dimethylformamide, N,N-diethylformamide, etc., an acetamido-type solvent such as N,N-dimethylacetamide, N,N-diethylacetamide, etc., a pyrrolidone-type solvent such as N-methyl-2-pyrrolidone, N-vinyl-2-pyrrolidone, hexamethylphosphoramide, γ-butyrolactone, etc.

(Fluororesin Powder (X))

The fluororesin powder (X) is made of a resin material (a) containing a fluororesin (B). The resin material (a) may contain components other than the fluororesin (B) within a range not to impair the effects of the present invention.

In 100 mass % of the resin material (a), the proportion of the fluororesin (B) is preferably from 80 to 100 mass %, more preferably from 85 to 100 mass %, further preferably from 90 to 100 mass %. When the proportion is within the above range, the effects of the present invention will be unlikely to be impaired.

In a case where other components are contained in the resin material (α), in 100 mass % of the resin material (α), the total proportion of other components is preferably from more than 0 to 20 mass %, more preferably from more than 0 to 15 mass %, further preferably from more than 0 to 10 mass %. When the above proportion is within the above range, the effects of the present invention will be unlikely to be impaired. It is also preferred that the resin material (α) does not contain other components.

The average particle diameter of the fluororesin powder (X) is preferably from 0.02 to 200 μm, more preferably from 1 to 100 μm. When the average particle diameter is at least the lower limit value in the above range, work handling efficiency of the powder will be excellent. When the average particle diameter is at most the upper limit value in the above range, outer appearance and abrasion resistance of the cured product or the fiber-reinforced molded product will be remarkably excellent.

The fluororesin powder (X) may be produced, for example, by the following procedure.

The fluororesin (B) and, as the case requires, other components are melt-kneaded. A melt of the resin material (α) is extruded in a form of strands. The strands are cut and pelletized by a pelletizer. The pellets are mechanically pulverized. The pulverized product is classified to obtain a fluororesin powder (X).

The apparatus capable of mechanically pulverizing pellets may be a hammer mill, a pin mill, a disk mill, a rotary mill, a jet mill, a fluidized bed air jet mill, a jaw crusher, a gyratory crusher, a cage mill, a pan crusher, a ball mill, a pebble mill, a rod mill, a tube mill, a disk attrition mill, an attritor, a disk refiner, etc.

Pulverization of pellets is preferably carried out by cooling the pellets to a temperature of at most −40° C., since it is thereby easy to reduce the average particle diameter of the pulverized product. The cooling temperature is more preferably at most −100° C., further preferably at most −160° C. The cooling method may be a method of using dry ice or liquid nitrogen.

(Fluororesin (B))

The fluororesin (B) is a fluororesin having functional groups of at least one type selected from the group consisting of carbonyl group-containing groups, hydroxy groups, epoxy groups and isocyanate groups (hereinafter referred to as functional groups (f)). By having functional groups (f), the fluororesin powder (X) tends to readily be dispersed in the thermosetting resin (A), whereby outer appearance and abrasion resistance of the cured product or the fiber-reinforced molded product will be excellent.

The functional groups (f) are, from the viewpoint of excellent outer appearance and abrasion resistance of the cured product or the fiber-reinforced molded product, preferably present as either one or both of the main chain terminal groups and the main chain pendant groups of the fluororesin (B). The functional groups (f) may be of one type, or may be of two or more types.

The fluororesin (B) preferably has at least carbonyl group-containing groups as the functional groups (f), from the viewpoint of excellent outer appearance and abrasion resistance of the cured product or the fiber-reinforced molded product.

A carbonyl group-containing group may, for example, be a group having a carbonyl group between carbon atoms of a hydrocarbon group, a carbonate group, a carboxy group, a haloformyl group, an alkoxycarbonyl group, an acid anhydride group, etc.

In the group having a carbonyl group between carbon atoms of a hydrocarbon group, the hydrocarbon group may, for example, be an alkylene group having from 2 to 8 carbon atoms. Here, the number of carbon atoms in the alkylene group is the number of carbon atoms in the state not including carbon atoms constituting the carbonyl group. The alkylene group may be linear or may be branched.

The haloformyl group is represented by —C(═O)—X (wherein X is a halogen atom). As the halogen atom in the haloformyl group, a fluorine atom, a chlorine atom, etc. may be mentioned, and a fluorine atom is preferred. That is, as the haloformyl group, a fluoroformyl group (referred to also as a carbonyl fluoride group) is preferred.

The alkoxy group in the alkoxycarbonyl group may be linear or may be branched, and it is preferably an alkoxy group having from 1 to 8 carbon atoms, particularly preferably a methoxy group or an ethoxy group.

The content of functional groups (f) in the fluororesin (B) is preferably from 10 to 60,000 groups, more preferably from 100 to 50,000 groups, further preferably from 100 to 10,000 groups, particularly preferably from 300 to 5,000 groups, to 1×10⁶ carbon atoms in the main chain of the fluororesin (B). When the content is at least the lower limit value in the above range, the outer appearance and abrasion resistance of the cured product or the fiber-reinforced molded product will be remarkably excellent. When the content is at most the upper limit value in the above range, even if the temperature at the time of molding the prepreg is made low, the outer appearance and abrasion resistance of the cured product or the fiber-reinforced molded product will be excellent.

The content of functional groups (f) can be measured by a method such as a nuclear magnetic resonance (NMR) analysis, an infrared absorption spectrum analysis, etc. For example, using a method such as an infrared absorption spectrum analysis as described in JP-A-2007-314720, the proportion (mol %) of units having functional groups (f) in all units constituting the fluororesin (B) is obtained, and from the proportion, the content of functional groups (f) can be calculated.

The melting point of the fluororesin (B) is from 100 to 325° C., preferably from 100 to less than 260° C., more preferably from 120 to 220° C. When the melting point is at least the lower limit value in the above range, heat resistance of the cured product or the fiber-reinforced molded product will be excellent. When the melting point is at most the upper limit value in the above range, it is possible to use a common device at the time of producing the cured product or the fiber-reinforced molded product, and outer appearance and abrasion resistance of the cured product or the fiber-reinforced molded product will be excellent.

In a case where a fluororesin (B) having a relatively low melting point is employed, even if the temperature at the time of molding the prepreg is made to be low, the outer appearance and abrasion resistance of the cured product or the fiber-reinforced molded product will be excellent. Thus, in such a case, the melting point of the fluororesin (B) is preferably from 120 to 220° C., more preferably from 120 to 200° C.

The melting point of the fluororesin (B) may be adjusted by the types or proportions of the units constituting the fluororesin (B), the molecular weight of the fluororesin (B), etc. For example, there is a tendency that the melting point rises, as the proportion of the units (u1) to be described later, becomes large.

As the fluororesin (B), a melt-moldable one is used from such a viewpoint that it is thereby easy to produce a powder, a resin film and a prepreg.

The melt-moldable fluororesin (B) may be a fluororesin having functional groups (f) introduced to a known melt-moldable fluororesin (such as a tetrafluoroethylene/fluoroalkyl vinyl ether copolymer, a tetrafluoroethylene/hexafluoropropylene copolymer, an ethylene/tetrafluoroethylene copolymer, polyvinylidene fluoride, polychlorotrifluoroethylene or an ethylene/chlorotrifluoroethylene copolymer), a fluorinated polymer (B11) to be described later, etc.

As the fluororesin (B), one is used whereby a temperature at which the melt flow rate becomes to be from 0.1 to 1,000 g/10 min. is present under a load of 49N at a temperature higher by at least 20° C. than the melting point of the fluororesin (B). The melt flow rate is preferably from 0.5 to 100 g/10 min., more preferably from 1 to 30 g/10 min., further preferably from 5 to 20 g/10 min. When the melt flow rate is at least the lower limit value in the above range, moldability of the fluororesin (B) will be excellent. When the melt flow rate is at most the upper limit value in the above range, mechanical properties of the cured product or the fiber-reinforced molded product will be excellent.

As the fluororesin (B), by the difference in the production method, for example, the following ones may be mentioned.

Fluororesin (B1): A fluorinated polymer having functional groups (f) derived from at least one member selected from the group consisting of a monomer, a chain transfer agent and a polymerization initiator used at the time of the production of the fluorinated polymer. Hereinafter, the fluororesin (B1) may be referred to also as the polymer (B1).

Fluororesin (B2): A fluororesin having functional groups (f) introduced to a fluororesin having no functional group (f), by surface treatment such as corona discharge treatment, plasma treatment, etc.

Fluororesin (B3): A fluororesin obtained by graft-polymerizing a monomer having a functional group (f) to a fluororesin having no functional group (f).

As the fluororesin (B), for the following reasons, the polymer (B1) is preferred.
In the polymer (B1), in either one or both of the main chain terminal groups and the main chain pendant groups of the polymer (B1), a functional group (f) is present, whereby the outer appearance and abrasion resistance of the cured product or the fiber-reinforced molded product will be remarkably excellent.
Functional groups (f) in the fluororesin (B2) are unstable, because they are formed by surface treatment, and are likely to disappear as time passes.

In a case where functional groups (f) in the polymer (B1) are derived from a monomer used in the production of the polymer (B1), the polymer (B1) may be prepared by the following method (i). In such a case, the functional groups (f) are present in units derived from the monomer, which were formed by polymerization of the monomer at the time of the production.

Method (i): At the time of producing the polymer (B1) by polymerization of a monomer, a monomer having a functional group (f) is used.

In a case where functional groups (f) in the polymer (B1) are derived from a chain transfer agent used in the production of the polymer (B1), the polymer (B1) may be prepared by the following method (ii). In such a case, the functional group (f) is present as a terminal group of the main chain of the polymer (B1).

Method (ii): In the presence of a chain transfer agent having a functional group (f), the polymer (B1) is produced by polymerization of a monomer.

The chain transfer agent having a functional group (f) may be acetic acid, acetic anhydride, methyl acetate, ethylene glycol, propylene glycol, etc.

In a case where functional groups (f) in the polymer (B1) are derived from a polymerization initiator used in the production of the polymer (B1), the polymer (B1) may be prepared by the following method (iii). In such a case, the functional group (f) is present as a terminal group of the main chain of the polymer (B1).

Method (iii): In the presence of a polymerization initiator such as a radical polymerization initiator having a functional group (f), the polymer (B1) is produced by polymerization of a monomer.

The radical polymerization initiator having a functional group (f) may be di-n-propyl peroxydicarbonate, diisopropyl peroxycarbonate, tert-butylperoxy isopropyl carbonate, bis(4-tert-butylcyclohexyl) peroxydicarbonate, di-2-ethylhexyl peroxydicarbonate, etc.

In a case where functional groups (f) in the polymer (B1) are derived from at least two members among a monomer, a chain transfer agent and a polymerization initiator used in the production of the polymer (B1), it is possible to produce the polymer (B1) by combining at least two among the methods (i) to (iii).

As the fluororesin (B), the polymer (B1) produced by the method (i) is preferred from such a viewpoint that the content of functional groups (f) can be easily controlled and thus, it is easy to adjust the outer appearance of the cured product or the fiber-reinforced molded product.

The monomer having a functional group (f) may be a monomer having a carboxy group (maleic acid, itaconic acid, citraconic acid, undecylenic acid, etc.); a monomer having an acid anhydride group (itaconic anhydride (hereinafter referred to also as “IAH”), citraconic anhydride (hereinafter referred to also as “CAH”), 5-norbornene-2,3-dicarboxylic anhydride (hereinafter referred to also as “NAH”), maleic anhydride, etc.), a monomer having a hydroxy group or an epoxy group (hydroxybutyl vinyl ether, glycidyl vinyl ether, etc.), etc.

Polymer (B11)

As the polymer (B1) having functional groups (f) derived from a monomer, the following polymer (B11) is particularly preferred from such a viewpoint that the outer appearance and abrasion resistance of the cured product or the fiber-reinforced molded product will be remarkably excellent.

A polymer (B11) comprising units (u1) derived from tetrafluoroethylene (hereinafter referred to also as “TFE”) or chlorotrifluoroethylene (hereinafter referred to also as “CTFE”), units (u2) derived from a cyclic hydrocarbon monomer having an acid anhydride group (hereinafter referred to also as an “acid anhydride group-containing cyclic hydrocarbon monomer”), and units (u3) derived from the fluorinated monomer (but excluding TFE and CTFE). Here, acid anhydride groups in the units (u2) correspond to functional groups (f).

The acid anhydride group-containing cyclic hydrocarbon monomer to constitute units (u2) may be IAH, CAH, NAH, maleic anhydride, etc. As the acid anhydride group-containing cyclic hydrocarbon monomer, one type may be used alone, or two or more types may be used in combination.

As the acid anhydride group-containing cyclic hydrocarbon monomer, preferred is at least one member selected from the group consisting of IAH, CAH and NAH, and when at least one member selected from the group consisting of IAH, CAH and NAH is used, it is possible to easily produce a polymer (B11) having acid anhydride groups without using a special polymerization method (see JP-A-11-193312) which is required when using maleic acid anhydride.

As the acid anhydride group-containing cyclic hydrocarbon monomer, from such a viewpoint that the outer appearance and abrasion resistance of the cured product or the fiber-reinforced molded product will be remarkably excellent, IAH or NAH is preferred.

As the fluorinated monomer to constitute units (u3), preferred is a fluorinated compound having one carbon-carbon double bond, and for example, a fluoroolefin (vinyl fluoride, vinylidene fluoride, trifluoroethylene, hexafluoropropylene (hereinafter referred to also as “HFP”), hexafluoroisobutylene, etc., but excluding TFE), CF₂═CFOR^{f1} (wherein R^{f1} is a C₁₋₁₀ perfluoroalkyl group which may contain an oxygen atom between carbon atoms) (hereinafter referred to also as “PAVE”), CF₂═CFOR^{f2}SO₂X¹ (wherein R^{f2} is a C₁₋₁₀ perfluoroalkylene group which may contain an oxygen atom between carbon atoms, and X¹ is a halogen atom or a hydroxy group), CF₂═CFOR^{f3}CO₂X² (wherein R^{f3} is a C₁₋₁₀ perfluoroalkylene group which may contain an oxygen atom between carbon atoms, and X² is a hydrogen atom or a C₁₋₃ alkyl group), CF₂═CF(CF₂)ₚOCF═CF₂ (wherein p is 1 or 2), CH₂═CX³(CF₂)_{q}X⁴ (wherein X³ is a hydrogen atom or a fluorine atom, q is an integer of from 2 to 10, and X⁴ is a hydrogen atom or a fluorine atom) (hereinafter referred to also as “FAE”), a fluorinated monomer having a ring structure (perfluoro(2,2-dimethyl-1,3-dioxole), 2,2,4-trifluoro-5-trifluoromethoxy-1,3-dioxole, perfluoro(2-methylene-4-methyl-1,3-dioxolane), etc.), etc. may be mentioned.

As the fluorinated monomer, from such a viewpoint that the moldability of the polymer (B11) and the bending resistance of the fluororesin layer will be excellent, preferred is at least one member selected from the group consisting of HFP, PAVE and FAE, and more preferred is either one or both of FAE and HFP.

As PAVE, CF₂═CFOCF₂CF₃, CF₂═CFOCF₂CF₂CF₃, CF₂═CFOCF₂CF₂CF₂CF₃, CF₂═CFO(CF₂)₆F, etc. may be mentioned, and CF₂═CFOCF₂CF₂CF₃ (hereinafter referred to also as “PPVE”) is preferred.

As FAE, CH₂═CF(CF₂)₂F, CH₂═CF(CF₂)₃F, CH₂═CF(CF₂)₄F, CH₂═CF(CF₂)₅F, CH₂═CF(CF₂)₈F, CH₂═CF(CF₂)₂H, CH₂═CF(CF₂)₃H, CH₂═CF(CF₂)₄H, CH₂═CF(CF₂)₅H, CH₂═CF(CF₂H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₅H, CH₂═CH(CF₂)₆H, etc. may be mentioned.

As FAE, preferred is CH₂═CH(CF₂)_{q1}X⁴ (wherein q1 is from 2 to 6, preferably from 2 to 4), more preferred is CH₂═CH(CF₂)₂F, CH₂═CH(CF₂)₃F, CH₂═CH(CF₂)₄F, CH₂═CF(CF₂)₃H or CH₂═CF(CF₂)₄H, and particularly preferred is CH₂═CH(CF₂)₄F or CH₂═CH(CF₂)₂F.

The polymer (B11) may have units (u4) derived from a monomer having no fluorine (but excluding an acid anhydride group-containing cyclic hydrocarbon monomer) in addition to the units (u1) to (u3).

As the monomer having no fluorine, a compound having one polymerizable carbon-carbon double bond and having no fluorine is preferred, and, for example, an olefin (ethylene (hereinafter referred to also as “E”), propylene, 1-butene, etc.), a vinyl ester (vinyl acetate, etc.), etc. may be mentioned. As the monomer having no fluorine, one type may be used alone, or two or more types may be used in combination.

As the monomer having no fluorine, from such a viewpoint that mechanical properties, etc. of the cured product or the fiber-reinforced molded product will be excellent, ethylene, propylene or 1-butene is preferred, and ethylene is particularly preferred.

In the case of having no units (u4), preferred proportions of the respective units are as follows.

The proportion of units (u1) is preferably from 90 to 99.89 mol %, more preferably from 95 to 99.47 mol %, further preferably from 96 to 98.95 mol %, to 100 mol % of the total of units (u1), units (u2) and units (u3).

The proportion of units (u2) is preferably from 0.01 to 3 mol %, more preferably from 0.03 to 2 mol %, further preferably from 0.05 to 1 mol %, to 100 mol % of the total of units (u1), units (u2) and units (u3).

The proportion of units (u3) is preferably from 0.1 to 9.99 mol %, more preferably from 0.5 to 9.97 mol %, further preferably from 1 to 9.95 mol %, to 100 mol % of the total of units (u1), units (u2) and units (u3).

In a case where units (u4) are derived from ethylene, preferred proportions of the respective units are as follows.

The proportion of units (u1) is preferably from 25 to 80 mol %, more preferably from 40 to 65 mol %, further preferably from 45 to 63 mol %, to 100 mol % of the total of units (u1), units (u2), units (u3) and units (u4).

The proportion of units (u2) is preferably from 0.01 to 5 mol %, more preferably from 0.03 to 3 mol %, further preferably from 0.05 to 1 mol %, to 100 mol % of the total of units (u1), units (u2), units (u3) and units (u4).

The proportion of units (u3) is preferably from 0.2 to 20 mol %, more preferably from 0.5 to 15 mol %, further preferably from 1 to 12 mol %, to 100 mol % of the total of units (u1), units (u2), units (u3) and units (u4).

The proportion of units (u4) is preferably from 20 to 75 mol %, more preferably from 35 to 50 mol %, further preferably from 37 to 55 mol %, to 100 mol % of the total of units (u1), units (u2), units (u3) and units (u4).

When the proportions of the respective units are within the above ranges, the flame retardance, chemical resistance, etc. of the cured product or the fiber-reinforced molded product will be remarkably excellent.

When the proportion of units (u2) is within the above range, the amount of acid anhydride groups in the polymer (B11) becomes proper, whereby the outer appearance and abrasion resistance of the cured product or the fiber-reinforced molded product will be remarkably excellent.

When the proportion of units (u3) is within the above range, the moldability of the polymer (B11) and the bending resistance, etc. of the cured product or the fiber-reinforced molded product will be remarkably excellent.

The proportions of the respective units can be calculated by the melt NMR analysis, fluorine content analysis, infrared absorption spectrum analysis, etc. of the polymer (B11).

In the polymer (B11), part of acid anhydride groups in units (u2) is hydrolyzed, and as a result, there may be a case where units derived from the dicarboxylic acid (itaconic acid, citraconic acid, 5-norbornene-2,3-dicarboxylic acid, maleic acid, etc.)

corresponding to the anhydride group-containing cyclic hydrocarbon monomer, are contained. In a case where units derived from the dicarboxylic acid are contained, the proportion of such units shall be included in the proportion of units (u2).

Preferred examples of the polymer (B11) may be a TFE/NAH/PPVE copolymer, a TFE/IAH/PPVE copolymer, a TFE/CAH/PPVE copolymer, a TFE/IAH/HFP copolymer, a TFE/CAH/HFP copolymer, a TFE/IAH/CH₂═CH(CF₂)₄F/E copolymer, a TFE/CAH/CH₂═CH(CF₂)₄F/E copolymer, a TFE/IAH/CH₂═CH(CF₂)₂F/E copolymer, a TFE/CAH/CH₂═CH(CF₂)₂F/E copolymer, a TFE/IAH/HFP/CH₂═CH(CF₂)₄F/E copolymer, etc.

Method for Producing Fluororesin (B)

The fluororesin (B) may be produced by conventional methods. In a case where a fluororesin (B) is produced by polymerization of monomers, as the polymerization method, it is preferred to use a polymerization method using a radical polymerization initiator.

As the polymerization method, a bulk polymerization method, a solution polymerization method using an organic solvent (a fluorinated hydrocarbon, a chlorinated hydrocarbon, a fluorinated chlorinated hydrocarbon, an alcohol, a hydrocarbon, etc.), a suspension polymerization method using an aqueous medium and, as the case requires, an appropriate organic solvent, or an emulsion polymerization method using an aqueous medium and an emulsifier, may be mentioned, and a solution polymerization method is preferred.

(Curing Agent (C))

The curing agent (C) may be suitably selected depending on the type of the thermosetting resin (A).

In a case where the thermosetting resin (A) is an epoxy resin, the curing agent (C) may be 4,4′-diaminodiphenyl sulfone, dicyandiamide, diaminodiphenylmethane, diaminodiphenyl ether, bisaniline, benzyl dimethyl aniline, etc.

In a case where the thermosetting resin (A) is a cyanate ester resin, the curing agent (C) is preferably a diepoxy compound, etc., from the viewpoint of improving the toughness of the cured product or the fiber-reinforced molded product.

In a case where the thermosetting resin (A) is other than an epoxy resin and a cyanate ester resin, as the curing agent (C), a known curing agent may be employed.

As the curing agent (C), one type may be used alone, or two or more types may be used in combination. Further, it is also preferred to use a commonly known curing catalyst together the curing agent (C).

(Thermoplastic Resin (D))

The thermoplastic resin (D) may be a crystalline resin, an amorphous resin, a thermoplastic elastomer, others (but excluding the same one as the fluororesin (B)).

The crystalline resin may be a polyester-type resin (polyethylene terephthalate, polybutylene terephthalate, polytrimethylene terephthalate, polyethylene naphthalate, liquid crystal polyester, etc.), a polyolefin-type resin (polyethylene, polypropylene, polybutylene, acid-modified polyethylene, acid-modified polypropylene, acid-modified polybutylene, etc.), polyoxymethylene, polyamide, a polyarylene sulfide resin (polyphenylene sulfide, etc.), polyketone, polyether ketone, polyether ether ketone, polyether ketone ketone, polyether nitrile, a fluororesin (polytetrafluoroethylene, etc.) other than the fluororesin (B), a liquid crystal polymer, etc.

The amorphous resin may be a styrene-type resin (polystyrene, an acrylonitrile-styrene resin, an acrylonitrile butadiene styrene resin), polycarbonate, polymethyl methacrylate, polyvinyl chloride, unmodified or modified polyphenylene ether, thermoplastic polyimide, polyamideimide, polyetherimide, polysulfone, polyether sulfone, polyarylate, etc.

The thermoplastic elastomer may be a polystyrene-type elastomer, a polyolefin-type elastomer, a polyurethane-type elastomer, a polyester-type elastomer, a polyamide-type elastomer, a polybutadiene-type elastomer, a polyisoprene-type elastomer, a fluorinated elastomer (but excluding the fluororesin (B)) an acrylonitrile-type elastomer, etc.

Others may be a phenol-type resin, a phenoxy resin, etc.

(Other Components)

Other components to be contained in the curable composition of the present invention, may be an inorganic filler, an organic filler, an organic pigment, a metal soap, a surfactant, an ultraviolet absorber, a lubricant, a silane coupling agent, an organic compound (such as an organic monomer, an organic oligomer having a polymerization degree of at most 50, etc.), etc. Particularly, an inorganic filler is preferred.

((Content) Proportions of the Respective Components)

In 100 mass % of the total of the thermosetting resin (A) and the fluororesin powder (X), the proportion of the thermosetting resin (A) is from 70.0 to 99.9 mass %, preferably from 92 to 99.9 mass %, more preferably from 93 to 99.5 mass %, particularly preferably from 95 to 99.2 mass %. When the proportion is at least the lower limit value in the above range, the fluororesin powder (X) tends to be easily dispersed in the thermosetting resin (A), and the outer appearance of the cured product or the fiber-reinforced molded product will be excellent. When the proportion is at most the upper limit value in the above range, the outer appearance and abrasion resistance of the cured product or the fiber-reinforced molded product will be excellent.

In 100 mass % of the total of the thermosetting resin (A) and the fluororesin powder (X), the proportion of the fluororesin powder (X) is from 0.1 to 30 mass %, preferably from 0.1 to 8 mass %, more preferably from 0.5 to 7 mass %, particularly preferably from 0.8 to 5 mass %. When the proportion is at least the lower limit value in the above range, the impact resistance and abrasion resistance of the cured product or the fiber-reinforced molded product will be excellent. When the proportion is at most the upper limit value in the above range, the fluorine resin powder (X) tends to be easily dispersed in the thermosetting resin (A), and the outer appearance and abrasion resistance of the cured product or the fiber-reinforced molded product will be excellent.

To 100 parts by mass of the total of the thermosetting resin (A) and the fluororesin powder (X), the content of the curing agent (C) is preferably from 25 to 45 parts by mass, more preferably from 30 to 35 parts by mass. When the addition amount of the curing agent (C) is within the above range, the heat resistance and mechanical properties of the cured product or the fiber-reinforced molded product will be excellent.

In 100 mass % of the curable composition of the present invention, the total proportion of the thermosetting resin (A), the fluororesin powder (X) and the curing agent (C) is preferably from 80 to 100 mass %, more preferably from 85 to 100 mass %, further preferably from 90 to 100 mass %. When the proportion is within the above range, the effects of the present invention will be unlikely to be impaired.

In 100 mass % of the curable composition of the present invention, the total proportion of the thermoplastic resin (D) and other components is preferably from 0 to 20 mass %, more preferably from 0 to 15 mass %, further preferably from 0 to 10 mass %. When the total proportion of the thermoplastic resin (D) and other components is within the above range, the effects of the present invention will be unlikely to be impaired.

Here, in a case where the thermosetting resin (A) contains a liquid medium, the above proportions of the respective components are based on the mass excluding the liquid medium. Also in a case where the fluororesin powder (X) or the curing agent (C) contains a liquid medium, the above proportions are based on the mass excluding the liquid medium.

### <Cured Product>

The cured product of the present invention is one obtained by curing the curable composition of the present invention. The cured product of the present invention may be formed on the surface of a substrate to form a laminate having a layer made of the cured product of the present invention and a layer made of the substrate.

The thickness of the cured product is preferably at most 5 mm, more preferably at most 4 mm. When the thickness of the cured product is at most the above upper limit value, at the time of producing a cured product by curing the curable composition, the fluororesin powder (X) is less likely to undergo phase separation or sedimentation in the curable composition. Thus, it is easy to obtain a cured product excellent in outer appearance. The lower limit in thickness of the cured product is not particularly limited, but from the viewpoint of abrasion resistance of the cured product, it is preferably at least 0.01 mm.

(Method for Producing Cured Product)

The method for producing a cured product of the present invention may, for example, be a method of injecting a curable composition into a mold cavity and curing the curable composition to form a cured product; or a method of applying a curable composition to the surface of a substrate and curing the curable composition to form a layer made of a cured product.

(Applications)

As applications of the curable composition and its cured product, metal laminates may be mentioned. As specific applications, resin materials for electronic components to be described later may be mentioned. As other applications, for example, the following ones may be mentioned, and a matrix resin for a prepreg or a fiber-reinforced molded product is preferred.

A matrix resin for a prepreg or a fiber-reinforced molded product. Resin materials, etc. for electronic components: a laminate for a printed wiring board, a build-up substrate layer, an interlayer insulating material, an adhesive film for build-up, a semiconductor encapsulating material, a die attach adhesive, a flip-chip mounting underfill material, globtop material a liquid encapsulant for TCP, a conductive adhesive, a liquid crystal sealing material, a flexible substrate coverlay, a resist ink, etc. Optical materials: an optical waveguide, an optical film, etc. A resin material for injection molding. Coating materials: an adhesive, an insulating paint, etc. Resin materials for optical semiconductor devices (LED, a phototransistor, a photodiode, a photocoupler, CCD, EPROM, a photosensor, etc.).

### <Prepreg>

The prepreg of the present invention comprises reinforcing fibers and a matrix resin. Specifically, it is a sheet-form material having a matrix resin impregnated to reinforcing fibers. Further, it may be said to be a material having reinforcing fibers embedded in a matrix resin. In the present invention, it is preferred that the matrix resin is in a semi-cured state.

(Reinforcing Fibers)

As the reinforcing fibers, from the viewpoint of mechanical properties of the fiber-reinforced molded product, continuous long fibers with a length of at least 10 mm are preferred. The reinforcing fibers need not be continuous over the entire length in the longitudinal direction or over the entire width in the width direction of the reinforcing fiber sheet, and they may be divided in the middle.

As a processed form of reinforcing fibers, from the viewpoint of mechanical properties of the fiber-reinforced molded product, one processed into a sheet (hereinafter referred to as a reinforcing fiber sheet) is preferred.

The reinforcing fiber sheet may be a reinforcing fiber bundle composed of a plurality of reinforcing fibers, a cloth made by weaving such reinforcing fiber bundles, an unidirectional reinforcing fiber bundle having a plurality of reinforcing fibers drawn in one direction, an unidirectional cloth composed of such unidirectional reinforcing fiber bundles, a combination thereof, one having a plurality of reinforcing fiber bundles stacked, etc.

The reinforcing fibers may be inorganic fibers, metal fibers, organic fibers, etc.

The inorganic fibers may be carbon fibers, graphite fibers, glass fibers, silicon carbide fibers, silicon nitride fibers, alumina fibers, silicon carbide fibers, boron fibers, etc.

The metal fibers may be aluminum fibers, brass fibers, stainless steel fibers, etc.

The organic fibers may be aromatic polyamide fibers, polyaramide fibers, polyparaphenylene benzoxazole (PBO) fibers, polyphenylene sulfide fibers, polyester fibers, acrylic fibers, nylon fibers, polyethylene fibers, etc.

The reinforcing fibers may be ones subjected to surface treatment. As the reinforcing fibers, one type may be used alone, or two or more types may be used in combination. As the reinforcing fibers, carbon fibers are preferred, since they have a small specific gravity, high strength and high modulus.

As the carbon fibers, those described in WO2013/129169 may be mentioned, and particularly, those described in [0018] to [0026] are preferred. Further, as a method for producing carbon fibers, one described in [0028] to [0033] may be mentioned.

(Matrix Resin)

The matrix resin is the curable composition of the present invention.

The prepreg of the present invention may be produced by letting the curable composition of the present invention be impregnated into a reinforcing fiber sheet.

### <Fiber-Reinforced Molded Product>

The fiber-reinforced molded product of the present invention is one formed by using the prepreg of the present invention.

The fiber-reinforced molded product of the present invention may be one formed by using only the prepreg of the present invention, or may be a laminate formed by using the prepreg of the present invention and another prepreg other than the prepreg of the present invention, or may be a laminate formed by using the prepreg of the present invention and, as the case requires, another prepreg, as well as another member other than the prepregs.

Another prepreg may, for example, be a prepreg wherein the matrix resin contains only a thermosetting resin (A) and does not contain a fluororesin (B), or a prepreg wherein the matrix resin contains a fluororesin (B) and does not contain a thermosetting resin (A).

Another member other than the prepregs may, for example, be a metal member; a resin film containing a thermosetting resin (A); or a resin film containing a fluororesin (B).

The metal member may, for example, be a metal foil, various metal parts, etc. The metal may, for example, be iron, stainless steel, aluminum, copper, brass, nickel, zinc, etc. The shape of the metal member is not particularly limited, and may be suitably selected depending upon the fiber-reinforced molded product to be obtained.

(Method for Producing Fiber-Reinforced Molded Product)

The fiber-reinforced molded product of the present invention may be obtained, for example, by molding, while heating, only one prepreg of the present invention, a stacked product having at least two prepregs of the present invention stacked, or a stacked product having at least one prepreg of the present invention, another prepreg and a member other than the pregregs stacked.

As the molding method, a press molding method using a mold, etc. may be mentioned.

(Applications)

As applications of the fiber-reinforced molded product, the following ones may be mentioned.

Housings for electrical and electronic equipment (personal computers, displays, OA equipment, mobile phones, personal digital assistants, facsimiles, compact discs, portable MD, portable radio cassettes, PDA (portable information terminals such as electronic organizers), video cameras, digital still cameras, optics, audio, air-conditioning, lighting, entertainment goods, toys goods, other household appliances, etc.), inner members (trays, chassis, etc.), cases for inner members, mechanical parts, etc. Building materials (panels), etc.

Automobile, motorcycle related parts, members and outer plates: motor parts, alternator terminals, alternator connectors, IC regulators, potentiometer for light deer base, suspension parts, various valves (exhaust gas valves, etc.), fuel-related, exhaust system or intake system various pipes, air intake nozzle snorkels, intake manifolds, various arms, various frames, various hinges, various bearings, fuel pumps, gasoline tanks, CNG tanks, engine cooling water joints, carburetor main body, carburetor spacers, exhaust gas sensors, coolant sensors, oil temperature sensors, brake pad wear sensors, throttle position sensors, crankshaft position sensors, air flow meters, brake pad wear sensors, air conditioning thermostat base, heating warm air flow control valves, brush holders for radiator motors, water pump impellers, turbine vanes, wiper motor-related parts, distributors, starter switches, starter relays, transmission wire harnesses, window washer nozzles, air conditioner panel switch boards, coils for fuel-related magnetic valves, fuse connectors, battery trays, AT brackets, head lamp supports, pedal housings, steering wheels, door beams, protectors, chassis, frames, arm rests, horn terminals, step motor rotors, lamp sockets, lamp reflectors, lamp housings, brake pistons, noise seals, radiator supports, spare tire covers, seat shells, solenoid bobbins, engine oil filters, ignition device cases, under covers, scuff plates, pillar trim, propeller shafts, wheels, fenders, fascia, bumpers, bumper beams, hoods, aero parts, platforms, cowl louvers, roofs, instrument panels, spoilers, various modules, etc.

Aircraft-related parts, members and outer plates: landing gear pods, winglets, spoilers, edges, ladders, elevators, failing, ribs, etc.

Other: blades of wind turbines, etc.

The fiber-reinforced molded product is preferably used particularly for aircraft components, windmill blades, automobile outer plates, and housings, trays, chassis, etc. of electronic devices.

### EXAMPLES

In the following, the present invention will be specifically described with reference to Examples, but the present invention is by no means construed as being limited thereto. Ex. 1, 2, 6 and 7 are Examples of the present invention, and Ex. 3 to 5 and 8 are Comparative Examples.

(Proportions of Units in Polymer (B1))

Obtained by a melt NMR analysis, a fluorine content analysis and an infrared absorption spectrum analysis.

(Content of Functional Groups (f))

By the following infrared absorption spectrum analysis, the proportion of units derived from NAH having a functional group (f) in the fluororesin (B), was obtained.

The fluororesin (B) was press-molded to obtain a 200 μm film. In the infrared absorption spectrum, the absorption peak in the units derived from NAH in the fluororesin (B) appears at 1,778 cm⁻¹. By measuring the absorbance of the absorption peak, and using a molar absorption coefficient of 20,810 mol⁻¹·I·cm⁻¹ of NAH, the proportion (mol %) of units derived from NAH was obtained.

When the above proportion is taken as a (mol %), the number of functional groups (f) (acid anhydride groups) to 1×10⁶ carbon atoms in the main chain, is calculated as [a×10⁶/100].

(Melting Point)

Using a differential scanning calorimeter (DSC apparatus, manufactured by Seiko Instruments Inc.), the melting peak at the time when the polymer was heated at a rate of 10° C./min. was recorded, whereby the temperature (° C.) corresponding to the maximum value was taken as the melting point.

(Melt Flow Rate)

Using a melt indexer (manufactured by Techno Seven Co.), the mass (g) of the polymer flowing out for 10 minutes from a nozzle having a diameter of 2 mm and a length of 8 mm under conditions of 372° C. and a load 49N, was measured.

(Average Particle Diameter)

The fluororesin powder (X) was dispersed in isopropyl alcohol by ultrasonic waves, and then, the volume-based cumulative 50% diameter (D50) was obtained by a laser diffraction/scattering particle size distribution analyzer (manufactured by HORIBA, Ltd., LA-920) and was taken as the average particle diameter.

(Outer Appearance)

A cured product was visually observed, and its outer appearance was evaluated by the following standards.

◯ (good): In the cured product, the fluororesin powder (X) is uniformly dispersed, the surface is smooth, and the outer appearance is excellent.

x (bad): In the cured product, the fluororesin powder (X) is aggregated, the surface is not smooth, and the outer appearance is poor.

(Abrasion Wear Amount)

Using a contour machine (manufactured by Amada Machine Tools Co., Ltd., V-400), a cured product was cut to obtain a circular test specimen having a diameter of 46 mm.

With respect to the test specimen, an abrasion wear test was carried out by using a Matsubara type abrasion wear tester (manufactured by Orientec Co.). The test specimen was fixed to a test jig, and to the test specimen, a counterpart material ring (material: SUS304, contact area: 2 cm²) was contacted under conditions of pressure: 7 kg/cm² (686.49 kPa), rotational speed: 0.5 m/s, and test time: 1 hour, whereby the abrasion wear amount was measured. The smaller the abrasion wear amount, the better the abrasion resistance.

(Thermosetting Resins (A))

Thermosetting resin (A-1): A bisphenol A type epoxy resin (manufactured by Adeka Corporation, Adeka Resin EP-4100).

Thermosetting resin (A-2): A dicyclopentadiene type epoxy resin (manufactured by DIC Corp., EPICLON HP-7200H-75M, liquid medium: MEK, solid content concentration: 75 mass %)

(Fluororesins (B))

Fluororesin (B-1): A fluorinated polymer having functional groups (f) (content of functional groups (f): 1,000 groups to 1×10⁶ carbon atoms in the main chain of the fluororesin (B-1), melting point: 300° C., melt flow rate (372° C., load 49N): 17.6 g/10 min.). The resin was produced in the same manner as in Example 5 of WO2015/182702, and the molar ratio of TFE/NAH/PPVE was 97.9/0.1/2.

Fluororesin (B′-2): A tetrafluoroethylene/perfluoro(alkyl vinyl ether) copolymer having no functional group (f) (Fluon (manufactured by Asahi Glass Company, Limited, registered trademark) PFA

P-63P, melting point: 300° C., melt flow rate (372° C., load 49N): 12.8 g/10 min.).

(Fluororesin Powders (X))

Fluororesin powder (X-1):

The pellets of fluororesin (B-1) were pulverized to obtain a fluororesin powder (X-1) having an average particle diameter of 3 μm.

Fluororesin powder (X′-2):

The pellets of the fluororesin (B′-2) were pulverized to obtain a fluororesin powder (X′-2) having an average particle diameter of 5 μm.

(Curing Agents (C))

Curing agent (C-1): 4,4′-diaminodiphenyl sulfone (manufactured by Wako Pure Chemical Industries, Ltd.).

Curing agent (C-2): A phenol novolac resin (manufactured by DIC Corp., trade name: Phenolite TD-2090-60M, solvent: MEK, solid content: 60 mass %)

(Thermoplastic Resin (D))

Thermoplastic resin (D-1): Polyether sulfone, Veradel (trade name of Solvay Advanced Polymers, 3000P).

### Ex. 1

The thermosetting resin (A-1) and the fluororesin powder (X-1) were mixed at 125° C. for 1.5 hours in the ratio shown in Table 1, and then, the curing agent (C-1) was added and mixed to obtain a curable composition. The curable composition was subjected to degassing treatment and then, injected into a mold (cavity size: a thickness of 4 mm, horizontal 16 cm, vertical 12 cm). The mold was put in a hot circulating oven, heated at 110° C. for 2 hours and then heated at 200° C. for 4 hours. The mold was gradually cooled, to obtain a cured product. The outer appearance of the cured product and the abrasion wear amount are shown in Table 1.

### Ex. 2 to 5

A cured product was obtained in the same manner as in Ex. 1 except that the types and amounts of the respective resins, and the amount of the curing agent (C-1) were changed as shown in Table 1. The outer appearance of the cured product and the abrasion wear amount are shown in Table 1.

TABLE 1

| | | Ex. 1 | Ex. 2 | Ex. 3 | Ex. 4 | Ex. 5 |
|---|---|---|---|---|---|---|
| Thermosetting resin (A) | | (A-1) | (A-1) | (A-1) | (A-1) | (A-1) |
| Fluororesin powder (X) | | (X-1) | (X-1) | — | (X′-2) | — |
| Thermoplastic resin (D) | | — | — | — | — | (D-1) |
| Curing agent (C) | | (C-1) | (C-1) | (C-1) | (C-1) | (C-1) |
| Proportions in curable | (A) | 74 | 73 | 75 | 73 | 73 |
| composition [mass %] | (X) | 1 | 3 | — | 3 | — |
| | (D) | — | — | — | — | 3 |
| | (C) | 25 | 24 | 25 | 24 | 24 |

| | | | | | |
|---|---|---|---|---|---|
| (X)/(A) [mass ratio] | 1.3/98.7 | 3.9/96.1 | — | 3.9/96.1 | — |
| Average particle diameter (μm) of | 3 | 3 | — | 5 | — |
| fluororesin powder (X) | | | | | |
| Outer appearance of cured product | ◯ | ◯ | — | X | ◯ |
| Abrasion wear amount (cm³) | 0.0082 | 0.0069 | 0.0151 | — | 0.0093 |

In Ex. 1 and 2 containing a fluororesin powder (X) having functional groups (f), the outer appearance was good as compared to Ex. 4 containing a fluororesin powder having no functional group (f).

In Ex. 1 and 2 containing a fluororesin powder (X), the abrasion resistance was excellent as compared to Ex. 3 and 5 not containing a fluororesin powder (X).

### Ex. 6

To the fluororesin powder (X-1), a surfactant (Newco) 1308, trade name of Nippon Nyukazai Co., Ltd.) was added so as to be 3 mass % relative to the fluororesin powder (X-1), and further methyl ethyl ketone (hereinafter referred to as “MEK”) was added so as to bring the solid content concentration to be 40 mass %, followed by stirring by a stirrer for 1 hour at 300 rpm and then for 15 minutes at 1,500 rpm. Then, ultrasonic treatment was carried out for 5 minutes by a ultrasonic homogenizer to obtain a dispersion of the fluororesin resin powder. Thereafter, to the thermosetting resin (A-2), the fluororesin powder (X-1) was added so that the proportion of the fluororesin powder (X-1) would be 20 mass % to 100 mass % of the total of the thermosetting resin (A-2) and the fluororesin powder (X-1).

Thereafter, the epoxy curing agent (C-2) was added so that the mass ratio of the thermosetting resin (A-2) to the epoxy curing agent (C-2) would be 26:9, followed by stirring for 20 minutes under a condition of 1,000 rpm by a stirrer to obtain a liquid composition. Then, the obtained liquid composition was filtered through a 100 mesh filter, and the liquid composition was applied on an electrolytic copper foil having a thickness of 12 μm (manufactured by Fukuda Metal Foil & Powder Co., Ltd., CF-T4X-SVR-12, surface roughness (Rz): 1.2 μm) and then dried in a hot air circulation type oven to obtain a one-side copper-clad laminate (1) of copper foil/film having a thickness of 60 μm. The outer appearance of the obtained cured product, and the abrasion wear amount are shown in Table 2. Here, in the mass calculation of (X-1), (A-2) and (C-2), the solvent was not taken into consideration, and the mass of only the solid contents was used.

### Ex. 7

A one-side copper-clad laminate of copper foil/film having a thickness of 60 μm was obtained in the same manner as in Ex. 6 except that after obtaining the dispersion of the fluororesin powder in the same procedure as in Ex. 6, the proportion of the fluororesin powder (X-1) was made to be 25 mass % in 100 mass % of the total of the thermosetting resin (A-2) and the fluororesin powder of (X-1). The outer appearance of the obtained cured product and the abrasion wear amount are shown in Table 2.

### Ex. 8

A one-side copper-clad laminate of copper foil/film was obtained by the same procedure as in Ex. 6 except that the fluororesin powder (X-1) was not used. The outer appearance of the obtained cured product and the abrasion wear amount are shown in Table 2.

Here, the abrasion wear amount in Table 2 was in accordance with the test method of the above-mentioned “abrasion wear amount” except for the following points. A test specimen obtained by cutting the one-side copper-clad laminate of copper foil/film by a cutter, was fixed to a test jig, and to this test specimen, a mating material ring was contacted under conditions of pressure: 1.5 kg/cm² (147.10 kPa), rotational speed: 0.5 m/sec. and test time: 3 min.

TABLE 2

| | | Ex. 6 | Ex. 7 | Ex. 8 |
|---|---|---|---|---|
| Thermosetting resin (A) | | A-2 | A-2 | A-2 |
| Fluororesin powder (X) | | X-1 | X-1 | — |
| Thermoplastic resin (D) | | — | — | — |
| Curing agent (C) | | C-2 | C-2 | C-2 |
| Proportions in curable | A | 63 | 60 | 74 |
| composition [mass %] | X | 16 | 20 | — |
| | D | — | — | — |
| | C | 21 | 20 | 26 |

| | | | |
|---|---|---|---|
| (X)/(A) [mass ratio] | 20/80 | 25/75 | — |
| Average particle diameter [μm] of | 3 | 3 | 3 |
| fluororesin powder (X) | | | |
| Outer appearance of cured product | ∘ | ∘ | ∘ |
| Thickness [mm] of specimen | 0.06 | 0.06 | 0.06 |
| Abrasion wear amount [cm³] | 0.00031 | 0.00027 | 0.0022 |

In Ex. 6 and 7 containing a fluororesin powder (X), abrasion resistance was excellent as compared to Ex. 8 not containing a fluororesin powder (X).

### INDUSTRIAL APPLICABILITY

The fiber-reinforced molded product of the present invention is useful as a member to constitute transport equipment (vehicles (automobiles, railway vehicles, etc.), aircrafts, etc.), construction, electrical and electronic equipment, etc.

This application is a continuation of PCT Application No. PCT/JP2017/000874, filed on Jan. 12, 2017, which is based upon and claims the benefit of priority from Japanese Patent Application No. 2016-005275 filed on Jan. 14, 2016. The contents of those applications are incorporated herein by reference in their entireties.

What is claimed is:

1. A curable composition comprising a thermosetting resin, a fluororesin powder and a curing agent, wherein the fluororesin powder is made of a resin material containing a melt-moldable fluororesin having a melting point of from 100 to 325° C. and having functional groups of at least one type selected from the group consisting of carbonyl group-containing groups, hydroxy groups, epoxy groups and isocyanate groups, and in 100 mass % of the total of the thermosetting resin and the fluororesin powder, the proportion of the thermosetting resin is from 70.0 to 99.9 mass % and the proportion of the fluororesin powder is from 0.1 to 30 mass %.

2. The curable composition according to claim 1, wherein in 100 mass % of the total of the thermosetting resin and the fluororesin powder, the proportion of the thermosetting resin is from 92 to 99.9% and the proportion of the fluororesin powder is from 0.1 to 8 mass %.

3. The curable composition according to claim 1, wherein the average particle diameter of the fluororesin powder is from 0.02 to 200 μm.

4. The curable composition according to claim 1, wherein the melting point of the fluororesin is from 100 to 260° C.

5. The curable composition according to claim 1, wherein the melt flow rate of the fluororesin is from 0.5 to 100 g/10 min. at a temperature higher by at least 20° C. than the melting point of the fluororesin (B) under a condition of a load of 49N.

6. The curable composition according to claim 1, wherein the fluororesin is a fluorinated polymer having functional groups (f) derived from at least one member selected from the group consisting of a monomer, a chain transfer agent and a polymerization initiator used at the time of producing the fluorinated polymer.

7. The curable composition according to claim 1, wherein the fluororesin is a fluorinated polymer comprising units derived from tetrafluoroethylene or chlorotrifluoroethylene, units derived from a cyclic hydrocarbon monomer having an acid anhydride group and units derived from a fluorinated monomer (excluding TFE and CTFE).

8. The curable composition according to claim 1, wherein the proportion of the curing agent is from 25 to 45 parts by mass, to 100 parts by mass of the total of the thermosetting resin (A) and the fluororesin powder (X).

9. A cured product of the curable composition as defined in claim 1.

10. The cured product according to claim 9, which has a thickness at most 5 mm.

11. A metal laminate plate having a metal layer on one side or each side of a layer composed of the cured product as defined in claim 9.

12. A prepreg comprising reinforcing fibers and a matrix resin, wherein the matrix resin is composed of the curable composition as defined in claim 1.

13. A fiber-reinforced molded product using the prepreg as defined in claim 12.
